(19) United States
(12) Patent Application Publication
(10) Pub. No.: US 2019/0113752 A1
(43) Pub. Date: Apr. 18, 2019

(54) HEAD MOUNTED DISPLAY DEVICE HAVING DISPLAY PANELS WITH ASYMMETRIC PANEL BORDERS FOR IMPROVED NASAL FOV

(71) Applicant: Google Inc., Mountain View, CA (US)

(72) Inventors: John Kaehler, Mountain View, CA (US); Ken Foo, Mountain View, CA (US); William Hamburgen, Mountain View, CA (US); Yi Tao, Mountain View, CA (US)

(21) Appl. No.: 15/625,581

(22) PCT Filed: Jun. 16, 2017
(86) PCT No.: PCT/US2017/037897

§ 371 Date: Jun. 16, 2017

Related U.S. Application Data
(60) Provisional application No. 62/357,518, filed on Jul. 1, 2016.

(51) Int. Cl. G02B 27/01

(52) U.S. Cl. CPC G02B 27/0172; G02B 27/0176; G02B 2027/0178; G02B 2027/0159; G02B 2027/0132

(57) ABSTRACT

A head mounted display (HMD) device includes a left-eye display panel and a right-eye display panel. Each of the left-eye and right-eye display panels includes a proximate edge, a distal edge, an active display area having a proximate border and a distal border. A distance between the proximate border and the proximate edge is less than a distance between the distal border and the distal edge. For each display panel, a first border region defined by the distal edge and the distal border contains circuitry for operating pixels of the active display area, whereas a second border region defined by the proximate edge and the proximate border is devoid of circuitry.

### CROSS-REFERENCE TO RELATED APPLICATIONS

The present applications claims priority to U.S. Provisional Patent Application Ser. No. 62/357,518 (Attorney Docket No. 1500-G16007-PR), entitled “Head Mounted Display Device Having Display Panels With Asymmetric Panel Borders For Improved Nasal FOV” and filed on Jul. 1, 2016, and to PCT Patent Application Ser. No. PCT/US2017/37897 (Attorney Docket No. 1500-G16007-PCT), entitled “Head Mounted Display Device Having Display Panels With Asymmetric Panel Borders For Improved Nasal FOV” and filed on Jun. 16, 2017, the entireties of which are incorporated by reference herein.

### BACKGROUND

### Field of the Disclosure

The present disclosure relates generally to virtual reality (VR) and augmented reality (AR) systems and, more particularly, to VR and AR systems employing head mounted display devices.

### Description of the Related Art

Head mounted display (HMD) devices display imagery representative of a VR or AR environment close to a user's eyes so as to provide the user a sense of “presence” in the VR or AR environment. In some HMD device designs, a separate display panel is provided for each eye, such that each display panel may be driven with imagery specific to the corresponding eye. To facilitate adjustment of the interpupillary distance (IPD) between the left-eye and right-eye lens assemblies, each lens assembly may have a fixed positional relationship with the corresponding display panel, and the display panel and corresponding lens assembly may be shifted left or right as a single unit. While this two-panel configuration provides more effective control over the imagery displayed for each eye, and at a higher resolution than single-panel HMD implementations, the width of the symmetrical lateral border regions of conventional display panels (that is, the regions between the active display area and the lateral edges of the display panels) can limit the field of view (FOV) in the nasal region of the HMD device.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear view of a head mounted display (HMD) device implementing a pair of display panels with asymmetric lateral borders in accordance with at least one embodiment of the present disclosure.

FIG. 2 is a diagram illustrating the pair of display panels of FIG. 1 in greater detail in accordance with at least one embodiment of the present disclosure.

FIG. 3 is a diagram illustrating a comparison of utilization of the symmetrical lateral borders of a conventional display panel to utilization of asymmetric lateral borders of a display panel in accordance with at least one embodiment of the present disclosure.

FIG. 4 is a diagram illustrating an example implementation of a display panel with asymmetrical lateral borders in accordance with at least one embodiment of the present disclosure.

FIG. 5 is a diagram illustrating a top-view of the HMD device of FIG. 1 in accordance with at least one embodiment of the present disclosure.

### DETAILED DESCRIPTION

Conventional display panels for HMD devices and other portable display devices are manufactured such that the active display area of the display panel is centered between the two lateral edges of the display panel. As a result, the conventional display panels have symmetric lateral borders; that is, the distance between the active display area and the right lateral edge is equal to the distance between the active display area and the left lateral edge. Thus, when such conventional display panels are implemented side-by-side in an HMD device, the widths of these proximal borders (that is, the left border of the right-eye display panel and the right border of the left-eye display panel) limits the lateral extent of the active display areas relative to the corresponding eye, and thereby resulting in an unnecessarily narrow field of view (FOV) in the nasal region of the HMD device. As the human vision system is most perceptive of detail and other visual information directly in front (i.e., in the nasal region), this limited nasal FOV can detract from the viewing experience and thus impede the user's sense of presence in the VR or AR environment presented via the HMD device.

The present disclosure describes various embodiments of display panels fabricated so as to have asymmetrical lateral borders such that a pair of such display panels implemented in an HMD device have asymmetric lateral border regions in which the proximal lateral border region or proximal border region (that is, the lateral border region closest to the user's nose when implemented in the HMD device) is narrowed and the distal lateral border region or distal border region (that is, the lateral border region closest to the user's temple when implemented in the HMD device) widened so that the active display area of the display panel is shifted toward the nasal region. This shift of the active display area toward the nasal region due to the narrowed proximal lateral border of the display panel facilitates one or both of an increase in the nasal FOV or a decrease in the minimum IPD that may be provided by the HMD device compared to HMD devices using a pair of equivalently-dimensioned conventional display panels.

As described in greater detail below, the asymmetry between the lateral borders of the display panel may be achieved by designing the display panel such that the gate driver circuitry, signal traces, and other in-panel circuitry for the active elements of the active display area are contained in the distal lateral border region while the proximal lateral border region is devoid of any circuitry and/or signal traces, and thus allowing the proximal lateral border region to be considerably smaller compared to conventional display panels in which both lateral border regions contain significant amounts of the drive circuitry and signal traces. This allows the proximal lateral border region to be dimensioned with a smaller width, primarily sufficient to permit an effective seal between a glass/polycarbonate transparent panel and the underlying substrate at the proximal lateral edge. Conversely, the distal lateral border may require widening compared to a conventional display panel fabrication so as to accommodate the additional circuitry and signal traces. This widening of the distal lateral border, narrowing of the proximal lateral border, and resulting shift of the active display area toward the nasal region improves nasal FOV, but consequently may decrease the temporal FOV relative to a conventional display panel with the same width for the active display area and same overall lateral width. However, as the human vision system is less sensitive to visual information at the periphery of vision, the reduction of the temporal FOV has less impact, and thus the improved nasal FOV, even at the expense of decreased temporal FOV, typically provides for an improved user experience.

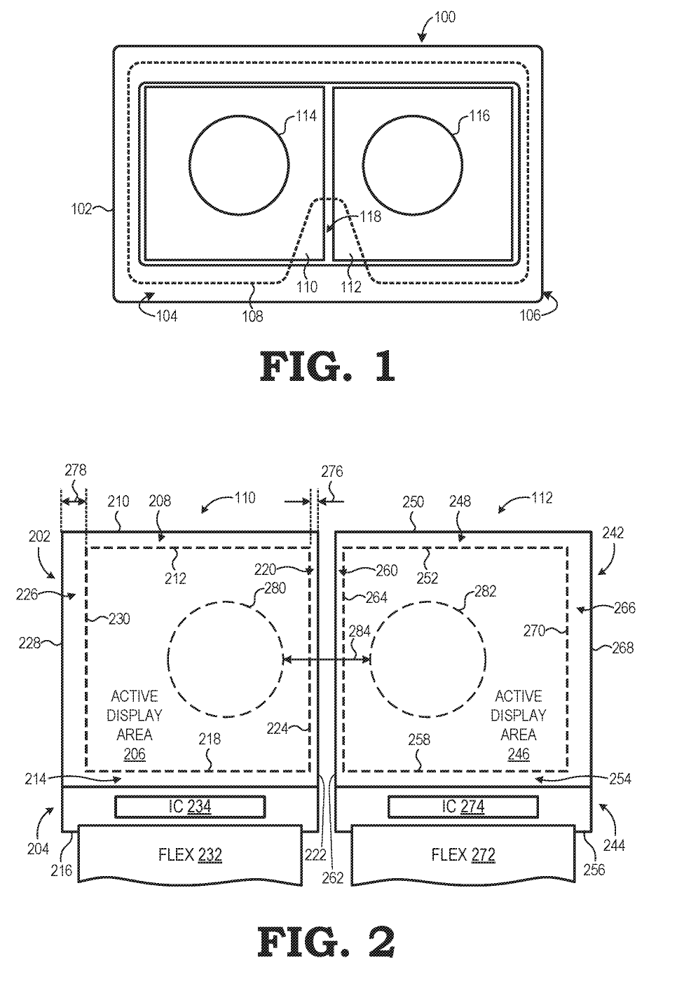

FIG. 1 illustrates an example HMD device 100 configured to implement a pair of display panels with asymmetric lateral borders in accordance with at least one embodiment. The HMD device 100 is mounted to the head of the user through the use of an apparatus strapped to, or otherwise mounted on, the user's head such that the HMD device 100 is fixedly positioned in proximity to the user's face and thus moves with the user's movements. However, in some circumstances a user may hold hand-held device up to the user's face and constrain the movement of the hand-held device such that the orientation of the hand-held device to the user's head is relatively fixed even as the user's head moves. In such instances, a hand-held device operated in this manner also may be considered an implementation of the HMD device 100 even though it is not “mounted” via a physical attachment to the user's head.

The HMD device 100 comprises a housing 102 having a user-facing surface 104 and an opposing forward-facing surface 106, and a face gasket 108 and set of straps or a harness (omitted from FIG. 1 for clarity) to mount the housing 102 on the user's head so that the user faces the surface 104 of the housing 102. In the depicted embodiment, the HMD device 100 is a binocular HMD and thus has a left-eye display panel 110 and a right-eye display panel 112 disposed at the surface 104. The housing 102 further includes an eyepiece lens assembly 114 aligned with the left-eye display panel 110 and an eyepiece lens assembly 116 aligned with the right-eye display panel 112. Although illustrated as a single lens, each of the eyepiece lens assemblies 114, 116 may comprise two or more lenses and other optical elements. As described in greater detail below, the eyepiece lens assembly 114 (or left-eye lens assembly 114) is aligned with the left-eye display panel 110, whereas the eyepiece lens assembly 116 (or right-eye lens assembly 116) is aligned with the right-eye display panel 112. The eyepiece lens assembly 114 and left-eye display panel 110 may be implemented as a single unit such that the left-eye lens assembly 114 has a fixed positional relationship with the left-eye display panel 110, and the right-eye lens assembly 116 and display panel 112 may similarly be implemented as a separate unit providing a fixed positional relationship. Accordingly, the HMD device 100 may include a mechanism (not shown) to shift the lateral position of one of these units relative to the other unit so as to provide for adjustment of the interpupillary distance (IPD) of the HMD device 100.

In at least one embodiment, the pair of display panels 110, 112 comprise a mirror pair of display panels with asymmetric lateral border regions such that the non-active lateral border region of each display panel that is proximal to the nasal region 118 of the HMD device 100 is narrower than the non-active lateral border region that is proximal to one of the temple regions of the HMD device 100 (and thus distal to the nasal region). This configuration is depicted in greater detail with reference to FIG. 2.

As shown in the example of FIG. 2, the left-eye display panel 110 includes a panel region 202 and an integrated circuit (IC) mount region 204. The panel region 202 includes an active display area 206 that contains the array of pixel elements (e.g., LED pixels, OLED pixels, LCD elements, etc.) used to emit light representative of imagery and which is surrounded by border regions (referred to herein as “borders” or “ledges”), including: a top ledge 208 defined by the top edge 210 of the display panel 110 and the top border 212 of the active display area 206; a bottom, or driver, ledge 214 defined by the bottom edge 216 of the display panel 110 and the bottom border 218 of the active display area 206; a proximal lateral border 220 (also referred herein as proximal border region 220) defined by the proximal lateral (right) edge 222 (also referred herein as proximal edge 222) of the display panel 110 and the proximal (right) border 224 of the active display area 206; and a distal lateral border 226 (also referred herein as distal border region 226) defined by the distal lateral (left) edge 228 (also referred herein as distal edge 228) of the display panel 110 and the distal (left) border 230 of the active display area 206. The proximal edge 222 is proximal the nasal region 118 of the HMD device 100 and the distal edge 228 is distal to the nasal region 118. Similarly, the proximal border 224 is proximal the nasal region 118 and the distal border 230 is distal to the nasal region 118. The IC mount region 204 includes a flex cable 232 or other wired or wireless interconnect to a control system (not shown) mounted thereon, as well as one or more driver IC packages 234 for controlling drive circuitry (not shown in FIG. 2) of the panel region 202 so as to selectively activate the pixel elements of the active display area 206 based on signaling received via the flex cable 232.

The right-eye display panel 112 is similarly configured, although as a mirror image, such that the right-eye display panel 112 includes a panel region 242 and an IC mount region 244. The panel region 242 includes an active display area 246 surrounded by: a top ledge 248 defined by the top edge 250 of the display panel 112 and the top border 252 of the active display area 246; a bottom, or driver, ledge 254 defined by the bottom edge 256 of the display panel 110 and the bottom border 258 of the active display area 246; a proximal lateral border 260 (or proximal border region 260) defined by the proximal lateral (left) edge 262 (or proximal edge 262) of the display panel 112 and the proximal (left) border 264 of the active display area 246; and a distal lateral border 266 (or distal border region 266) defined by the distal lateral (right) edge 268 (or distal edge 268) and the distal (right) border 270 of the active display area 246. The proximal edge 262 and proximal border 264 are proximal the nasal region 118 of the HMD device 100 and the distal edge 268 and distal border 270 are distal to the nasal region 118. The IC mount region 244 includes a flex cable 272 or other wired or wireless interconnect and one or more driver IC packages 274 mounted thereon.

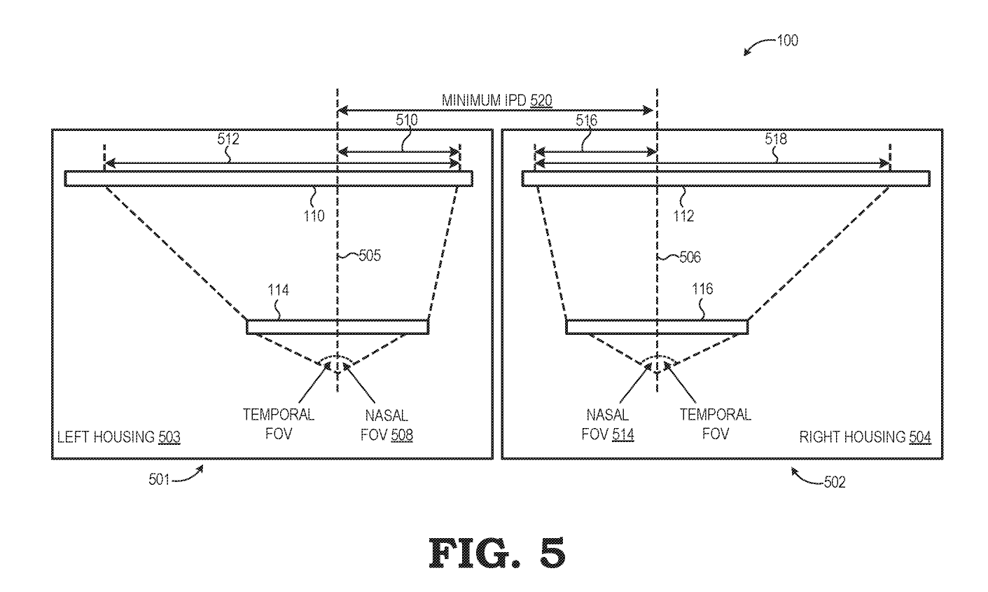

As shown in FIG. 2, the proximal lateral border 220 has a width 276 (that is, a distance between the proximal edge 222 and the proximal border 224) that is narrower than a width 278 (that is, the distance between the distal edge 228 and the distal border 230) of the distal lateral border 226. As a result, the active display area 206 is offset in the display panel 110 to the right toward the nasal region 118 (FIG. 1). Likewise, for the display panel 112, the proximal lateral border 260 likewise has a width equivalent to width 276 that is narrower than the width of the distal lateral border 266 (which is equivalent to the width 278), and thus the active display area 246 is offset in the display panel 112 to the left toward the nasal region 118. The widths 276 of the proximal lateral borders 220, 260, in at least one embodiment, are substantially narrower than the corresponding lateral borders found in dimensionally-equivalent conventional display panels with symmetric lateral borders. Thus, assuming that the positions 280, 282 of the lens assemblies 114, 116 are fixed relative to the corresponding display panel or that the positions 280, 282 are subject to a minimum relative distance 284 in between, the shifts of the active display areas 206, 246 toward the nasal region 118 as afforded by the narrower proximal lateral borders 220, 260 relative to conventional display panels of the same size permits a wider nasal FOV relative, as is described in greater detail below with reference to FIG. 5.

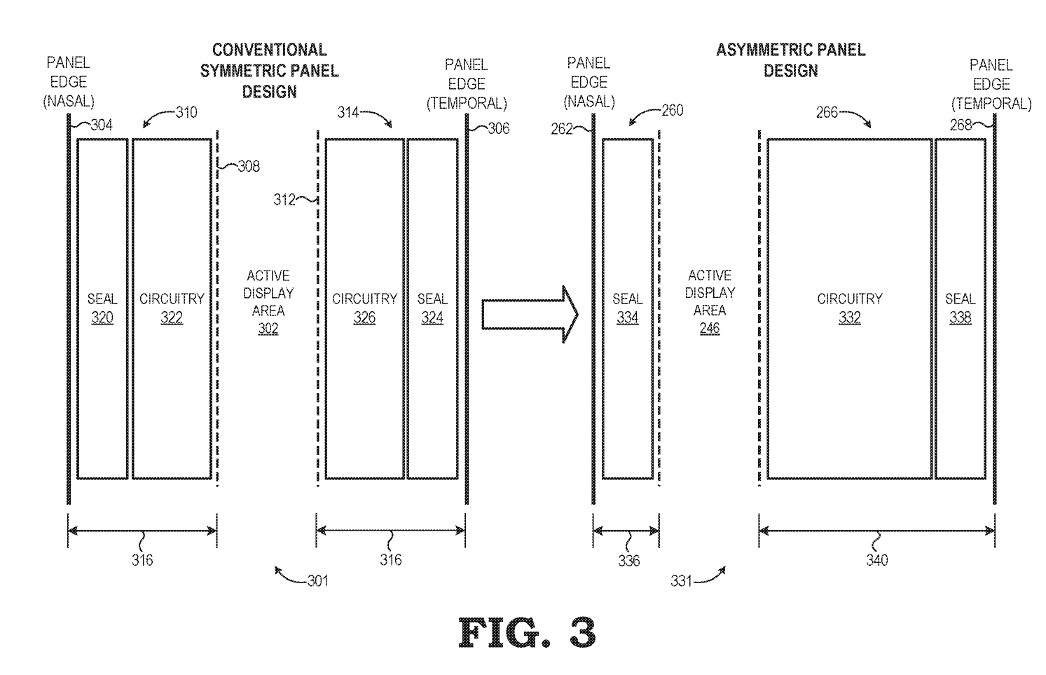

FIG. 3 illustrates an example design approach to facilitate narrowing of the proximal lateral border of a display panel so as to achieve a display panel with asymmetric lateral border regions in accordance with at least one embodiment. Diagram 301 illustrates a typical layout of the display region of a conventional display panel. As shown by diagram 301, a conventional display panel is designed so that the active display area 302 (not shown to scale) is centered between the opposing lateral panel edges 304, 306 such that the left lateral edge 308 of the active display area 302 and the left panel edge 304 define a left lateral border 310 and the right lateral edge 312 of the active display area 302 and the right panel ledge 306 define a right lateral border 314, and wherein the left lateral border 310 and the right lateral border 314 have substantially equal widths 316. In the conventional display panel, the left lateral border 310 is occupied by a seal region 320 containing a seal for sealing the substrate of the conventional display panel to its glass/plastic top transparent panel on the left side, as well as in-panel circuitry 322. Likewise, the right lateral border 314 is occupied by a seal region 324 containing a seal for sealing the right side, as well as in-panel circuitry 326. The seal regions 320, 324 may include, for example, epoxy end seals, glass frit end seals, thin-film encapsulation, and the like, depending on the type of display (e.g., liquid crystal display (LCD), LED, OLED, etc.). The in-panel circuitry 322, 326 typically includes integrated gate driver circuits, signal traces for power lines and global signal lines, and the like. Typically, in a conventional display panel, both lateral borders 310, 314 contain row driver circuits such that even rows of pixels of the active display area 302 are driven by the in-panel circuitry 322 and the odd rows of pixels are driven by the in-panel circuitry 326, or vice versa. That is, the conventional display panel design drives the active display area 302 by using in-panel circuitry on both lateral borders. As the seal typically requires 0.5 mm of lateral space, and as the in-panel circuitry typically requires between 0.5 mm and 1.5 mm of lateral space, depending on the dimensions of the transistors of the gate driver circuitry, the width 316 of each of the lateral borders 310, 314 typically is at least 1.0 mm to 2.0 mm.

Turning now to diagram 331, which represents the display panel 112 of FIGS. 1 and 2, a design approach for achieving asymmetric lateral borders is shown. In this implementation, rather than implement in-panel circuitry on both sides of the active display area 246, the distal lateral border 266 is designed to include most or all of the in-panel circuitry 332 for driving the active display area 246 (with the top ledge 248 and bottom ledge 254 potentially occupied with in-panel circuitry as well), while the proximal lateral border 260 is designed so to be devoid of such in-panel circuitry and associated signal traces. With this approach, only seal region 334 containing a corresponding seal may occupy the proximal lateral border 260, and thus the width 336 of the proximal lateral border 260 may be narrowed to the width of the seal in seal region 334 and some additional distance for tolerance purposes. However, because the in-panel circuitry that otherwise would be in the proximal lateral (left) border 260 is instead placed in the distal lateral (right) border 266, the lateral width of the in-panel circuitry 332 in the distal lateral border 266 likely will be greater than the width of either of the in-panel circuitry 322, 326 of the conventional display panel. Thus, when combined with the lateral width of a seal region 338 also occupying the distal lateral border 266, the width 340 of the distal lateral border 266 typically will be greater than the width 316 of the lateral border regions 310, 314 of a conventional display panel of comparable active display area size. In an example arrangement, the seal region 334 contains a seal for sealing a substrate of the display panel 112 to a transparent panel (not shown) of the display panel 112 (e.g. to a left side of the transparent panel). The transparent panel may be a glass/plastic top transparent panel. Seal region 338 contains a seal for sealing the substrate of the display panel 112 to the transparent panel (not shown) of the display panel 112 (e.g. to a right side of the transparent panel). The seal regions 334, 338 may include, for example, epoxy end seals, glass frit end seals, thin-film encapsulation, and the like, depending on the type of display (e.g., liquid crystal display (LCD), LED, OLED, etc.).

As such, referencing the example dimensions of the in-panel circuitry above, the proximal lateral border 260 may be at least 0.5 mm-1.5 mm narrower than the distal lateral border 266 as well as 0.5 mm-1.5 mm narrower than the proximal lateral border region of a conventional display panel of the same overall dimensions and same dimensions for the display active area. The increase in the width of the distal lateral border 266 compared to an equivalent conventional display panel may reduce the temporal FOV compared to the equivalent conventional display panel. However, as noted above, nasal FOV has a bigger impact on providing an accurate sense of presence to a user than temporal FOV, and thus this tradeoff typically provides an overall net benefit to the user's interaction with the HMD device 100 implementing a mirrored pair of such display panels.

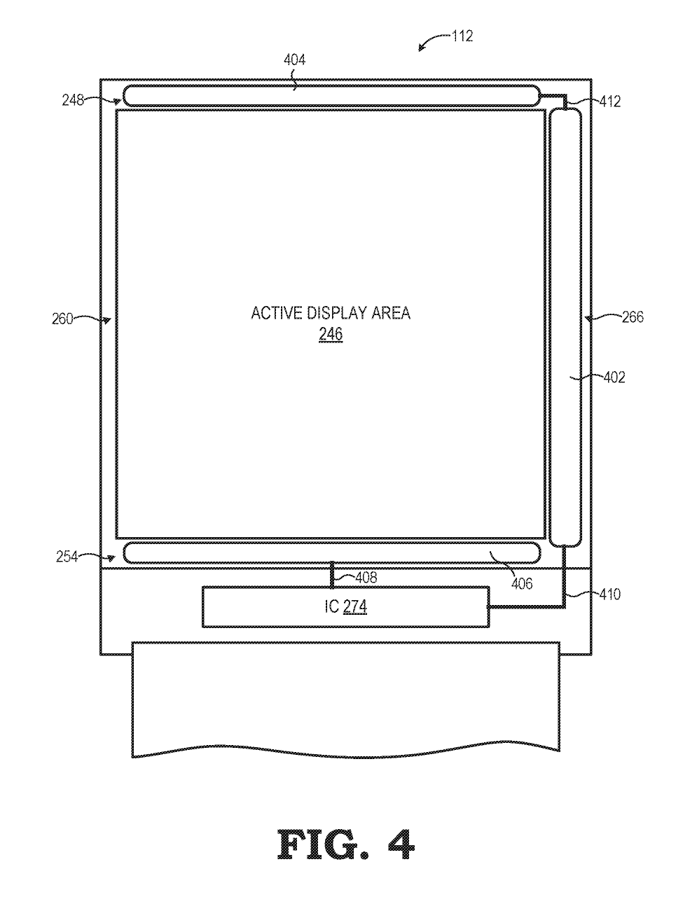

FIG. 4 illustrates an example implementation of the right-eye display panel 112 of FIG. 2 utilizing the design approach outlined above with respect to diagram 331 of FIG. 3. As shown, the distal lateral border 266 implements in-panel circuitry 402 (one embodiment of the in-panel circuitry 332) to drive the active display area 246. Likewise, the top ledge 248 also may implement in-panel circuitry (e.g., in-panel circuitry 404), as may the bottom ledge 254 (e.g., in-panel circuitry 406). The in-panel circuitry 402, 404, 406 is connected to the driver IC package 274 via signal traces (represented by signal traces 408, 410, 412) that are routed only in the distal lateral border 266, the top ledge 248, and the bottom ledge 254. In contrast, the proximal lateral border 260 is devoid of in-panel circuitry and may be devoid of signal traces, thereby permitting fabrication of the display panel 112 such that the proximal lateral border is considerably narrower than the distal lateral border 266.

FIG. 5 illustrates a simplified top view of the HMD device 100 with the pair of display panels 110, 112 with asymmetric lateral borders in accordance with some embodiments. As shown in the top view, the HMD device 100 includes two separate display units: a left-eye display unit 501 and a right-eye display unit 502. The left-eye display unit 501 includes a housing 503 that houses the left-eye display panel 110 and the eyepiece lens assembly 114, while the right-eye display unit 502 includes a housing 504 that houses the right-eye display panel 112 and the eyepiece lens assembly 116. In both units 501, 502, the eyepiece lens assembly has an optical axis (e.g., optical axes 505, 506) that intersects active display area of the corresponding display panel and is maintained in a fixed position relative to the corresponding display panel. Further, in this implementation, the units 501, 502 may be laterally shifted relative to each other using a mechanism (not shown) of the HMD device 100 so as to change the IPD between the eyepiece lens assemblies 114, 116.

Typically, the nasal FOV in an HMD device is constrained by the designed minimum IPD for the HMD design, which factors in the minimum gap between the left-eye display panel and right-eye display panel due to the thicknesses of housing walls, assembly tolerance, and the like. With the HMD device set at its minimum IPD, the primary factor in the nasal FOV is the nasal border size that is, the lateral width of the active display area between the optical axis and the proximal border of the active display area. Alternatively, the nasal FOV may be fixed as a design parameter for the HMD design. However, as the nasal FOV is a factor of both the nasal border width and the focal length of the corresponding lens assembly, a fixed value for the nasal FOV in turn constrains the minimum IPD for the HMD device.

To illustrate the relationship between the minimum IPD, nasal FOV, and nasal border width as parameters in an HMD device design, the HMD device design may be such that specification of the minimum IPD as, for example, 54 mm may require the nasal border width to be less than 1.5 mm, whereas if the HMD device design instead specifies a nasal FOV of 43 degrees and the nasal border width is this same 1.5 mm, the minimum IPD may have to be 58 mm or greater. Everything else being equal, it typically is desirable to have a low minimum IPD as possible so that the HMD device can accommodate a wider range of interpupillary distances, and thus accommodate a wider range of users.

As shown in FIG. 5, the HMD device 100 has a left-eye nasal FOV 508 that is a factor of the left-eye nasal border width 510 (the distance between the optical axis 505 and the right border or proximal border 224 of the active display area 206, as represented by width 512) and the focal length of the eyepiece lens assembly 114, and further has a right-eye nasal FOV 514 that is a factor of the right-eye nasal border width 516 (the distance between the optical axis 506 and the left border or proximal border 264 of the active display area 246, as represented by width 518). These parameters in turn impact the minimum IPD 520 of the design of the HMD device 100. However, because of the narrower proximal lateral border regions 220, 260 of the display panels 110, 112 compared to conventional display panels of the same dimensions, the design of the HMD device 100 may enjoy wider nasal FOVs 508, 514 compared to conventional HMD designs having the same specified minimum IPD 520, the HMD device 100 may enjoy a lower minimum IPD compared to conventional HMD designs having the same specified nasal FOVs, or the HMD device 100 may enjoy some combination of wider nasal FOVs 508, 514 and lower minimum IPD compared to conventional HMD designs. To illustrate, due to the asymmetric lateral border region design of the display panels 110, 112, the HMD device 100 may provide, for example, a nasal FOV of 40-45 degrees while allowing a minimum IPD of 54 mm.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A head mounted display (HMD) device comprising:
a left-eye display panel and a right-eye display panel, each of the left-eye and right-eye display panels comprising:
a proximal edge;
a distal edge;
an active display area having a proximal border and a distal border; and
wherein a distance between the proximal border and the proximal edge is less than a distance between the distal border and the distal edge.

2. The HMD device of claim 1, wherein:
a first border region defined by the distal edge and the distal border contains circuitry for operating pixels of the active display area; and
a second border region defined by the proximal edge and the proximal border is devoid of circuitry.

3. The HMD device of claim 2, wherein:
each of the left-eye and right-eye display panels includes a driver ledge positioned outside of the first and second border regions, the driver ledge comprising a driver integrated circuit (IC) package;
the first border region contains signal traces coupling the circuitry for operating the pixels of the active display area to the driver IC package; and
the second border region is devoid of signal traces.

4. The HMD device of claim 3, wherein:
each of the first and second border regions contains a seal region for sealing a substrate of the corresponding display panel to a transparent panel of the corresponding display panel.

5. The HMD device of claim 2, wherein:
each of the first and second border regions contains a seal region for sealing a substrate of the corresponding display panel to a transparent panel of the corresponding display panel.

6. The HMD device of claim 1, further comprising:
a left-eye lens assembly having an optical axis that intercepts the active display area of the left-eye display panel; and
a right-eye lens assembly having an optical axis that intercepts the active display area of the right-eye display panel.

7. The HMD device of claim 6, wherein the HMD device provides a nasal field of view of at least 40 degrees.

8. The HMD device of claim 7, wherein the HMD device provides a minimum inter-pupillary distance of 54 millimeters.

9. The HMD device of claim 1, wherein:
wherein the distance between the proximal border and the proximal edge is at least 0.5 millimeters shorter than the distance between the distal border and the distal edge.

10. The HMD device of claim 1, wherein:
wherein the distance between the proximal border and the proximal edge is at least 1.0 millimeter shorter than the distance between the distal border and the distal edge.

11. The HMD device of claim 1, wherein:
wherein the distance between the proximal border and the proximal edge is at least 1.5 millimeters shorter than the distance between the distal border and the distal edge.

12. A head-mounted display panel comprising:
a proximal edge;
a distal edge;
an active display area having a proximal border and a distal border; and
wherein a distance between the proximal border and the proximal edge is less than a distance between the distal border and the distal edge.

13. The head-mounted display panel of claim 12, wherein:
a first border region defined by the distal edge and the distal border contains circuitry for operating pixels of the active display area; and
a second border region defined by the proximal edge and the proximal border is devoid of circuitry.

14. The head-mounted display panel of claim 13, further comprising:
a driver ledge positioned outside of the first and second border regions, the driver ledge comprising a driver integrated circuit (IC) package;
the first border region contains signal traces coupling the circuitry for operating the pixels of the active display area to the driver IC package; and
the second border region is devoid of signal traces.

15. The head-mounted display panel of claim 14, wherein:
each of the first and second border regions contains a seal region for sealing a substrate of the corresponding display panel to a transparent panel of the corresponding display panel.

16. The head-mounted display panel of claim 13, wherein:
each of the first and second border regions contains a seal region for sealing a substrate of the corresponding display panel to a transparent panel of the corresponding display panel.

17. The head-mounted display panel of claim 12, wherein:
wherein the distance between the proximal border and the proximal edge is at least 0.5 millimeters shorter than the distance between the distal border and the distal edge.

18. The head-mounted display panel of claim 12, wherein:
wherein the distance between the proximal border and the proximal edge is at least 1.0 millimeter shorter than the distance between the distal border and the distal edge.

19. The head-mounted display panel of claim 12, wherein:
wherein the distance between the proximal border and the proximal edge is at least 1.5 millimeters shorter than the distance between the distal border and the distal edge.

20. The head-mounted display panel of claim 12, wherein:
the active display area comprises organic light emitting diode (OLED) pixels.

21. A method comprising:
providing a head mounted display (HMD) device comprising a left-eye display panel and a right-eye display panel, each of the left-eye and right-eye display panels comprising a proximal edge, a distal edge, an active display area having a proximal border and a distal border, and wherein a distance between the proximal border and the proximal edge is less than a distance between the distal border and the distal edge.

22. The method of claim 21, wherein:
providing the HMD device comprises providing the HMD device with a first border region defined by the distal edge and the distal border contains circuitry for operating pixels of the active display area and with a second border region defined by the proximal edge and the proximal border is devoid of circuitry.

23. The method of claim 22, wherein:
providing the HMD device comprises providing the HMD device with a driver ledge positioned outside of the first and second border regions, the driver ledge comprising a driver integrated circuit (IC) package, wherein the first border region contains signal traces coupling the circuitry for operating the pixels of the active display area to the driver IC package, and the second border region is devoid of signal traces.
